(19) United States
(12) Patent Application Publication
(10) Pub. No.: US 2015/0283932 A1
(43) Pub. Date: Oct. 8, 2015

(54) Arrays and method of private sheltering of occupied beds in aircraft

(71) Applicants: Vladimir Anatol Shreider, Sydney (AU); Natalia Shreider, Sydney (AU)

(72) Inventors: Vladimir Anatol Shreider, Sydney (AU); Natalia Shreider, Sydney (AU)

(21) Appl. No.: 13/999,945

(22) Filed: Apr. 8, 2014

(51) Int. Cl. B60N 3/00; A47C 19/20; A47C 19/00; B64D 11/00; B63G 8/00

(52) U.S. Cl. CPC B60N 3/008; B64D 11/00; B63G 8/00; A47C 19/005; A47C 19/202

(57) ABSTRACT

Beds are disposed into multistoried columns parallel to a longitudinal axis of an array and displaceable between an interior of a frame which shelters and supports and guides the beds through openings, and an aisle for occupying and vacating the beds. The bed comprises a front wall with a sealing means for closing off the opening, and side and end walls with sealing means and a head cowl for closing off private interiors at rests. The beds in the oblique-angled array are displaceable longitudinally at an acute angle to the axis and have front bins for closing off the openings. The beds in the axial straightforward array are displaceable transversally to their axes at below of private bins in the frame and on foldable trap-shields.

### CROSS-REFERENCE TO A RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates to economy arrays and methods of private sheltering of beds in straitened lodgings of vessels such as a liner aircraft and a submarine.

2. Description of the Related Art

In a passenger cabin of a big liner aircraft, a sailor quarter of a big submarine, there is a necessity to shelter a plurality of persons on flat horizontal rest beds in a straitened lodging. The beds have rest parts which are relatively pivotable in a vertical plane. It might be the necessity as well to create some individual bed privacy. Such privacy in the aircraft is created usually with divider boards which being located between the adjacent beds.

The present invention relates to straitened arrays primarily, but not exclusively, of the movable beds having such divider walls. Accordingly to this specification, the term “array of vessel beds” of aircrafts and submarines is used to denote arrangement of a proportion, or indeed possibly the totality, of the movable and privacy beds in such lodgings having the straitened interior. In our design, a major consideration is economical utilization of the interior of the cabin of the economy class that is maximizing the number of private sheltered beds and revenue from the beds which command a substantial premium with respect to economy seats.

In the nearest U.S. Pat. No. 8,348,195 there was presented an array of aircraft sleeper seats movable into sleeping mode. Such bed comprises a head rest, a back rest and a leg rest, a bed and seat pan or cushion parts and an ottoman, all of which are capable to move in a conventional manner when the seat is moved between sleeping mode and sitting mode. The individual beds have inter-bed dividers and are arranged in a chevron array or formation and two horizontal columns. All the beds in each column are parallel with each other and have central axes, and set at a “herring-bone” angle to the column direction and in particular to a longitudinal axis of the array. Such array is intended for the business class of a liner aircraft. Deficiencies of the known array are, at a first, a little number of the beds which are arrayed into one only story and as a result, very expensive array; and at a second, insufficient privacy of the beds because a low height of divider boards.

An object of the present invention is to provide improved arrays of a maximal plurality of maximally privatized and sheltered beds in a straitened interior of lodging such as a passenger cabin of the liner aircraft vessel or the submarine vessel.

### SUMMARY OF THE INVENTION

The first object of the present invention is to provide improved, oblique-angled and straightforward arrays of numbers of occupied vessel beds which being sheltered privately in a straitened interior of a lodging such as a passenger cabin of a liner aircraft vessel, for example. The second object of the present invention is to provide a method of occupation and private sheltering accommodation and vacation of the beds in the straitened interiors.

As a first embodiment of the array according to the invention, it is provided the oblique-angled array of the longitudinally displaceable and privately sheltered occupied beds, which comprising:

a plurality of horizontally and longitudinally displaceable elongate individual sleeper beds arranged for the array into a number of horizontal multistoried columns which being located alongside a number of aisles of the lodging and a longitudinal axis of the array, and in rows across the lodging, each of the beds having a central axis, an elongate pan, and head rest and back rest and leg rest portions of a cushion along the length of the pan, wherein the bed comprises a front end wall, in relation to an advancing direction of the displacement, which being disposed on a front end edge of the pan for sheltering the occupied bed, and a sealing means on edges of the wall; and

a number of frames each of which being at the column and faced to at least one the aisle, and having an interior for sheltering, supporting and guiding the occupied beds in the advancing and opposite returning directions, and facade openings, in relation to the adjacent side of the aisle, which generally connecting the interior and the aisle and being capable of passing through longitudinally the pan and the occupied head and back rest portions, and

drive means for effecting relative movement between the frame and the occupied bed,

wherein the directions being angled acutely with respect to the axis and sides of the aisle, and the wall being parallel to the sides of the aisle and capable of closing the opening, and the sealing means such as a resilient band and tube members disposed on the outsides of the wall, which being capable of engaging on sashes of the frame around the opening to close the interior of the frame in relation to its exterior and prevent the ingress of hindrances into the interior from the aisle; and

the drive means being to effect

occupation and vacation of the beds in sleeping mode from the head and back rest portions in the aisle, and

private sheltering accommodation of the occupied beds in the interior of the frame.

Moreover, each of the beds has a private bin which being disposed at ahead of the head portion on a front portion of the pan, and serving for further closing off the interior to facilitate the privacy of the sheltering accommodation, and having the front wall, and a side wall which being disposed on an outer side edge, in relation to the aisle, of the pan and parallel to the axis of the bed, and a rear wall which crossing the front wall and the side wall, and a second rear wall which being disposed on a rear end of the pan and crossing the axis of the bed and parallel the longitudinal axis of the array, and the sealing means at the side wall and the rear walls for engaging on the storied bed which being adjacent from above to close off an allotted private interior of the frame at the bed in relation to its exterior and prevent the ingress of hindrances into the interior from the exterior. The bin is provided with a movable door member which being disposed at an opening in a ceiling of the bin.

The pan has an elongate horizontal portion and a front ascent portion, which front portions are forming a transversal horizontal passage having generally >-shaped cross-section and serving to facilitate the occupation and vacation of the bed which being adjacent from aside.

The bed further comprises a passage manhole throughout the back rest portion, which is serving to facilitate the occupation and vacating of the storied above bed, and a back rest cover which is pivotally connected to the pan and can be pivoted between an operative horizontal rest position and an inoperative vertical position whereby the cover can in the operative position close the manhole, and in the inoperative position open the manhole.

The bed is further provided with a head cowl which being disposed at the head portion and serving to close off a private head lot of the interior at the sheltered head rest portion, which cowl having a visor portion which is pivotally connected to the pan and can be pivoted between a lower operative position and an upper inoperative position, and an apron portion which being capable of forming an opening for surrounding the neck, and a sealing collar portion at the opening for engaging on the neck to close off the head interior lot of the cowl in relation to its exterior and prevent the ingress.

A second variant of the embodiment of the array according to the invention that comprises:

a plurality of horizontally and transversally displaceable individual sleeper beds arranged for the array in horizontal multistoried columns which being located alongside at least one aisle of the lodging on respective sides of a longitudinal axis of the array and in rows across the lodging, each of the beds having a central axis and a pan and head rest and back rest and thigh rest and feet and shin rest portions of a cushion on the pan, and

wherein the bed has a front side wall, relative to the direction of advancement, which being supported on a front side edge of the pan for private sheltering of the sheltered bed, and sealing means on outer edges of the wall for engaging thereon; and

a number of frames each of which being at the column. and

drive means for effecting relative movement between each of the frames and a number of the beds,

wherein the frame having an interior for sheltering accommodation and supporting and guiding a number of the occupied beds in horizontal, advancing and opposite returning directions which being perpendicular to the central and longitudinal axes and the sides of the aisle, and the plurality of facade openings, in relation to the adjacent side of the aisle, which generally connecting the interior and the aisle and being capable of surrounding opposite ends of the occupied bed, and a means for supporting and guiding the bed in the perpendicular directions; and

the drive means being to effect:

occupation and vacation of each of the beds in the aisle, and

private sheltering of the occupied beds in the interior,

whereby the wall and the sealing means are capable of closing off the opening, and the sealing means is capable of engaging on sashes of the frame at around the opening to close off the opening in relation to the aisle and prevent the ingress of hindrances into the interior from the aisle.

The shin and feet rest bed portion is a shin and feet rest member of the bed, which being pivotally supported on the thigh rest portion and capable to be pivoted into a vertical inoperative position to open a vertical passage portion of the aisle toward the thigh rest portion, which passage portion serving to facilitate the simultaneous occupying and vacating of the above storied bed.

The array further comprises a number of pivotable trap-shields for supporting and guiding the beds in the directions and closing off the openings and the interiors, wherein each of the trap-shields which is foldable and being composed of a main trap-shield part which being pivotally connected to the frame and capable to be pivoted between a vertical operative closing off position and a horizontal operative supporting and guiding position, and a side trap-shield part serving to facilitate the occupying and vacating of the bed and being pivotally connected to the main trap-shield part and capable to be pivoted between a co-planed, upper vertical closing off and lower horizontal, supporting and guiding operative position and a transversal lower vertical inoperative position whereby in the inoperative position the side member forms a portion of the aisle to place the bent feet and thin.

A group of the adjacent horizontally beds can be pivotally connected together and at least one the outer bed, in relation to the frame, can be pivoted in the aisle into a vertical inoperative position.

The array further comprises the plurality of private bins each of which being disposed in the interior of the frame between the adjacent vertically thin rest portions and with a vertical clearance from the thin rest portion of the adjacent lower bed. The clearance is equal to no lesser than about 20 centimeters and no more than about 25 centimeters.

The second aspect of the invention is a method of private sheltering occupied sleeper beds arrayed in a lodging, the method comprising:

operating a drive means to advance an occupied in sleeping mode bed in relation to a frame which shelters, supports and guides the occupied bed to displace through an opening of the frame into an adjacent aisle so as to open rest portions of the bed in the aisle;

occupying the opened rest portions in sitting mode and all rest portions of the bed in lying mode;

operating the drive means to shift the bed occupied in lying mode in the opposite return direction to cause the opened rest portions to stow through the opening into the frame to be sheltered, and a front wall with a sealing means on a front edge of a pan of the bed to engage on sashes of the frame at around the opening and close off the opening to prevent the ingress of hindrances to the occupied rest portions from the aisle.

The engaging of the sealing means on the frame is effected by operating the drive means operable to urge the front wall toward the frame. The privacy of the sheltering of the occupied bed is further effected by utilizing side and rear walls on an intended side edge and a rear edge of the pan, and sealing means at edges of the side and rear walls, which are capable of engaging on adjacent outsides. The engaging of the sealing means that is effected by utilizing resilient sealing members capable of urging against the adjacent outside s in relation to the walls.

The occupying and vacating of the bed is facilitated by displacing a feet and thin rest pan or a back rest part of the bed into a inoperative position to open a vertical passage portion of the aisle toward the rest portion for occupying and vacating the bed in sitting mode and then in sleeper mode.

The method further comprises the steps of: displacing closing off and supporting and guiding, main and side trap-shield parts of a trap-shield in relation to the frame which supports and guides the trap-shield so as to open the bed into the aisle; displacing the side part into an inoperative position to form a passage portion of the aisle for occupying in sitting mode a thigh rest portion of the bed or vacating back and head rest portions of the bed; displacing the trap-shield and the sealing means in relation to the frame so as to partly closing off the opening with the main member and its sealing means; and displacing the side member and its sealing means in relation to the main member so as to completely close off the opening.

The method further comprises the steps of occupation of a group of the beds: operating a drive means to advance a group of a few of the parallel beds which being pivotally connected together in side-by-side order so as the outer bed, in relation to the frame, is pivoted into a vertical inoperative position in the aisle, and the inner bed is displaced in an operative horizontal position into the aisle, and occupying the inner bed in sleeper mode; operating the drive means to shift the group in the returning direction so as the inner occupied bed is displaced into the frame, and the outer bed is pivoted into a horizontal operative position in the aisle; occupying the outer bed in sleeper mode; operating the drive means to shift the group in the returning direction so as the occupied group is displaced into the frame;

and further comprising the following steps of vacation of the group of the adjacent bed: operating the drive means to advance the group of the occupied beds in the transversal direction so as the outer occupied bed is displaced into the horizontal operative position in the aisle to be vacated; vacating the outer bed; operating the drive means to further advance the group of the beds so as the outer vacated bed is pivot into the vertical inoperative position in the aisle, and the inner occupied bed is displaced in the horizontal operative position into the aisle to be vacated; vacating the outer bed.

### BRIEF DESCRIPTION OF THE DRAWINGS

To help understanding of the invention, specific embodiments thereof will now be described by way of examples and with reference to the accompanying drawings wherein:

FIG. 1 is schematic cross-section views of a left side portion of an oblique-angled array and a right side portion of a straightforward array of multistory columned and private sheltered movable rest beds in cabins of liner aircraft or submarine vessels in accordance with the invention;

FIG. 2 is plan views of the left side portion of the oblique-angled array and the right side portion of the straightforward array shown in FIG. 1.

### DETAILED DESCRIPTION OF PREFERRED EMBODIMENTS

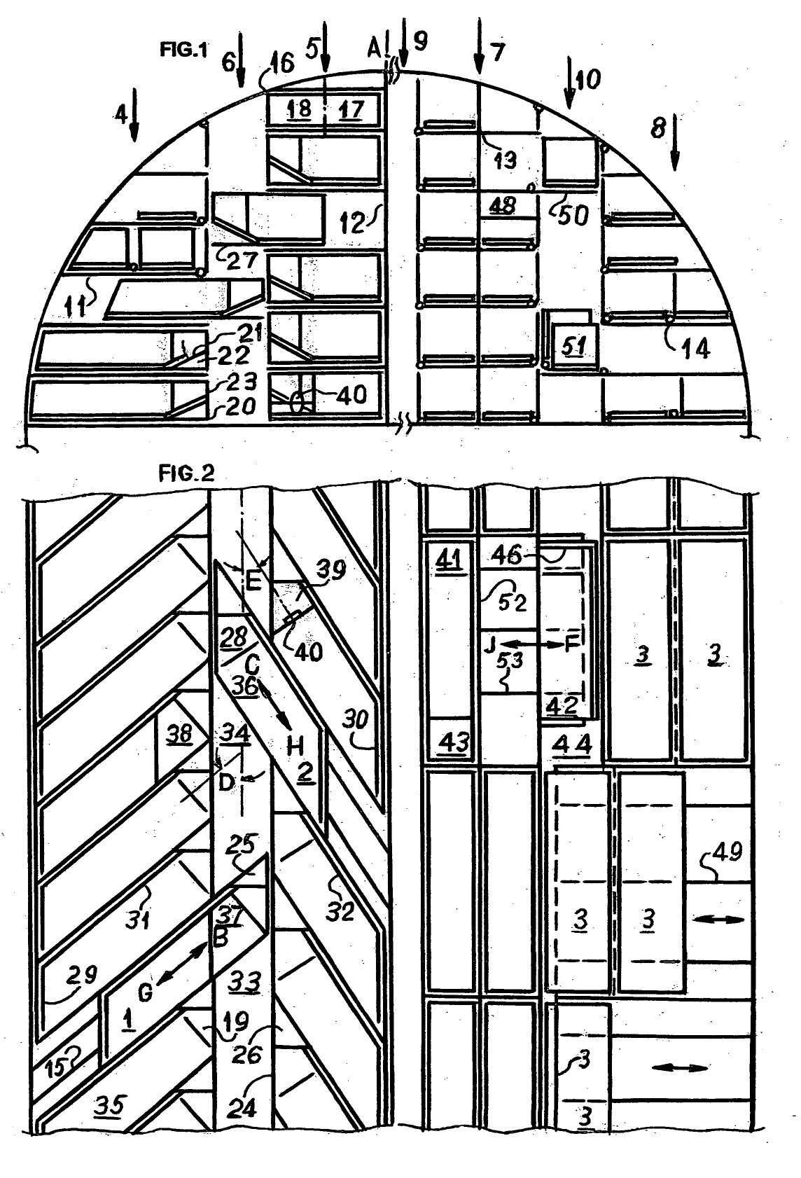

Straitened lodgings, such as passenger cabins of an economy class of a liner aircraft vessel, for example, which are schematically shown in FIGS. 1 and 2 as symmetrical in relation to a central longitudinal axis A of the cabins a left side half and a right side half of arrays of pluralities of private rest sleeper bed means 1 and 2 and 3 which are preferably elongate and vertically multistoried and horizontally columned along the axis A. The beds 1 and 2 are displaceable longitudinally according to the invention, and the beds 3 are parallel and displaceable transversally according to the invention, in horizontal planes. Each of the beds has a central longitudinal axis and conventional head and back and legs rest cushion and pan portions or part members (will be explained later).

A first, preferable oblique-angled embodiment of the array of the analogous in construction beds 1 and 2 that is shown in a left side half of FIGS. 1 and 2 and has a left side horizontal multistoried column 4 of the beds 1 and a left central multistoried column 5 of the beds 2 which are located along left and right sides of a left gangway or aisle 6 of the lodging, which being parallel to the axis A, for passing persons such as passengers or sailors when the persons are occupying and vacating the beds 1 and 2 (symmetrically located, in relation to the axis A, right side and central columns and an aisle are not shown).

A second, preferable straightforward embodiment of the array is shown in a right half of FIGS. 1 and 2 for the beds 3 which are displaceable transversally in relation to the axis A and their central longitudinal axes. The straightforward array has a right central horizontal multistoried column 7 and a right side horizontal multistoried column 8 (symmetrically located in relation to the axis A left columns are not shown) of the plurality of the beds 3 which are arranged along a central aisle 9 and a right aisle 10 (a symmetrically located left aisle is not shown) which being parallel to the axis A and used for passing persons which are occupying and vacating the beds 3. According to the invention, the beds 1 are capable to be privately sheltered in an interior (not shown) of a left side frame means 11, and the beds 2 are capable to be privately sheltered in an interior (not shown) of a left portion of a central frame means 12. The beds 1 and 2 can be advanced longitudinally in directions shown with arrows B and C which are crossing the axis A at acute angles which are shown with arrows D and E in FIG. 2 so that front, in relation to the advancing directions, rest cushion and pan portions of the beds 1 and 2 can be opened as cantilevers or consoles into the aisle 6 for occupation and vacation. Quantities of the angles D and E are correspondingly equal to about 50° and 30°, for example, and depended from the width of the frames 11 and 12, which is equal to about, for instance, 150 and 100 centimeters correspondingly, and the width of the aisle 6, which is equal to about, for instance, 50 centimeters.

The beds 3 are shown in the right side portions of FIGS. 1 and 2, and capable to be private sheltered in interiors (not shown) of a right central frame means 13 and a right side frame means 14, and advanced transversally in directions shown with an arrow F in FIG. 2 in relation to the frames 13 and 14 and their longitudinal axes and the axis A and the sides and axes of the aisles 8 and 10 and opened into the aisle 9 and 10 for occupation and vacation.

Each frame 11 throughout 14 has preferably a lattice construction, the interior and a number of facade, in relation to the aisle, sash portions of openings (not shown) generally connecting the corresponding interior and the aisle 6 and/or 9 and/or 10. The beds 1 and 2 and 3 can be displaced individually or in groups, forward and backward in returning directions shown with corresponding arrows G and H and J in FIG. 2 into the interiors of the frames 11 throughout 14 to be private sheltered and prevented from the ingress of outsider hindrances, such as noise, light, wind and dust, smoke and smell from their exteriors and the aisles 6 and/or 9 and/or 10.

The frames 11 throughout 14 are provided in their interiors with conventional rut groups of parallel rails and/or saddles and/or rollers, which all are shown conditionally as the ruts of the rails 15 for supporting and guiding the corresponding beds 1 or 2 or 3. Accordingly to the invention, the rails 15 of the frame 11 and 12 are being oriented in the corresponding directions shown by the arrows B and G, and C and H at the openings with the corresponding acute angles D and E to the axis and the sides of the aisle 6, and the rails 15 of the frame 13 and 14 are being oriented perpendicularly in respect to the axes of the aisles 9 and 10. The sash portions are capable of surrounding and passing through longitudinally the occupied beds 1 and 2 and transversally the occupied beds 3.

To displace the beds 1 and 2 and 3 there are provided drive means such as conventional, well-known electrical screw hoists and sprockets and/or mesh and rack means (not shown) which are secured to each of the frames 11 throughout 14 and connected via linkages or brackets to the respective associated beds or groups of the beds 1 or 2 or 3. It is possible to provide the drive means for each the bed or alternately each drive means may serve to displace the group of the several beds. In this latter case some appropriate connecting means can be provided to connect the beds of the group together. The drive means are capable of effecting relative movement between the corresponding frames and the beds to open portions of the beds into the aisle through the openings and possibility to occupy each of the beds and vacate each of the occupied beds in the aisle at ahead of the openings, and stowing and sheltering the beds at behind the openings in the interiors.

The columns 4 and 5, and 7 and 8 are formed having vertical pitches of stories of the corresponding beds 1 and 2 and 3, which pitches are equal to no more than 50 centimeters, as shown for the columns 5 and 8, for example, and no lesser than 40 centimeters, as shown for the columns 4 and 7, for example, and must be approved in accordance with corresponding sanitary regulations.

Numbers of conventional handles and steps (not shown) can be provided on the frames 11 throughout 14 at the openings in a vertical order and on the beds 1 and 2 and 3 in a horizontal order for serving to facilitate the occupation and vacation of the beds. Each of the beds 1 and 2 and 3 can be provided with conventional appliances for controlling the displacements, connecting to the crew, electrical lighting, air conditioning, listening in radio and watching television program (not shown).

According to the invention, upper and relative narrow stories of the side frame 11, which can be used for the straightforward array of the beds 3. A number of carousel bin means 16 are being disposed along the length of the upper story of the column 5. Each of the carousels 16 has a plurality, six for example, of radial divider walls 17 and private sectorial luggage bins 18, and a vertical axis of rotation.

According to the invention, in a first variant of the embodiment of the bed 1, the head rest 19 of the bed 1 as shown in FIG. 1 that has a front, in relation to the advancing direction shown with an arrow D, horizontal pan portion 20 and a second front pan portion 21 disposed at above and sloppily upwards at an acute angle which is equal to about 30°, for instance, in relation to the pan portion 20. The pan portions 20 and 21 form a horizontal niche-shaped corridor or passage portion 22 of the aisle 6, which having a <-shaped cross-section and the height which is equal up to about 15 centimeters and the depth about 30 centimeters, for instance.

According to the invention, each of the beds 1 and 2 which is provided with a facade, in relation to the aisle 6, front wall 23 and front wall 24 correspondingly, and a facade triangular prismatic bin means 25 and a facade triangular prismatic bin means 26 correspondingly for accommodating private luggage. The wall 23 and the bin 25 are being supported from above on a front edge of the upper pan portion 21 at ahead of the head rest portion 19, and the front wall 24 and the bin 26 are being supported on a front edge of a pan portion 27 of the bed 2 at ahead of a head rest portion 28. A rear end wall 29 and a rear end wall 30, and at least one side wall 31 and a side wall 32 are disposed oppositely to vertical passage portions 33 and 34 of the aisle 6, which being located at aside of the corresponding head rest portions 19 and 28 and the back rest portions 35 and 36 and serving as a side entrance and exit passage between the aisle 6 and the corresponding bed 1 and 2 for the occupation and vacation.

The front walls 23 and 24 and the bins 25 and 26 and the rear walls 29 and 30 and the side walls 31 and 32 can be made of conventional firm and insulate materials such as aluminum and glass-fiber sheets, and have edges which are provided with conventional sealing means such as a resilient band and tube members (not shown). The sealing means of the rear walls 29 and 30 and the side walls 31 and 32 which are capable of engaging from below on the pan portion 20 and 27 of the adjacent from above bed 1 and 2 or a portion of the frame 11 and 12, and the sealing means of the front wall 23 and 24 and the bin 25 and 26 are capable of engaging from ahead on the sash portions of the frame 11 and 12. The sealing means are capable of closing off the openings of the frames 11 and 12 in relation to their exteriors and the aisle 6 and prevent the ingress of outside hindrances such as noise, light, wind and dust, smell and smoke into the interiors from the aisle 6.

In the first variant of the embodiment, an occupation and vacation area at the bed 1 and 2, which includes the head rest portion 19 and the opened back rest portion 35 and 36, and the passage portions 22 and 33 and 34 of the aisle 6, and is being disposed at behind the bin 25 and 26 and the wall 23 and 24 and aside of the wall 31 and 32, and has the width which is equal up to about 125 centimeters, for example.

An occupation and vacation area at the bed 2, which includes the passage portion 34 and the head rest portion 28 and the opened back rest portion 36 and has the width which is equal to about 125 centimeters, for example, and can be increased with using a passage portion like the passage portion 22 of the bed 1 up to about 200 centimeters.

According to the invention, in a second variant of the embodiment, the back rest portion 35 of the beds 1, for instance, which can have a vertical passage trap opening 37 which is serving to facilitate the occupation and vacation of the bed 1, and a back rest trap-door member 38 which is pivotally connected to the pan portion 20 and capable to be pivoted between the horizontal operative closing-off and rest position and a vertical inoperative position whereby in the inoperative position the trap-door 38 opens the opening 37. The widths of the opening 37 are equal to about 50 centimeters, for example,

Accordingly to the invention, the beds 1 and 2 and 3 can be further provided with a head cowl means serving to facilitate the closing-off of a private head interior at the head of an occupying person against the ingress (see above) and comprising a visor member 39 which is pivotally connected to the side wall 32, for example, at the head rest portion 28 and can be pivoted between a lower operative closing-off position and an upper inoperative position, and has an apron and collar portion 40 of a soft material such as a silk cloth, whereby the collar portion 40 can be engaged on the neck of the person which is lying on the bed 1.

During an operation of occupation of the bed 1 or 2 according to the invention, the bed 1 or 2 or a group of the beds 1 or 2 which is advanced by supplying energy to the drive means associated therewith (not shown) in the corresponding direction shown with the arrows B or C in FIG. 2 to put through the corresponding opening of the frame 11 or 12 and open partly into the axle 6. Then an occupying person can move through the passage portion 33 or 34, and sit down on the opened head rest portion 19 or 28 and the back rest portion 35 or 36 and move the shins and feet throughout the passage portion 22 of the adjacent bed 1 or past the bin 26 of the adjacent bed 2 and extend into the opening of the frame 11 or 12 along the length of the further back rest portion and leg rest portion of the bed 1 or 2 so that to occupy the bed 1 or 2 in sleeping mode.

During a second variant of the operation of occupation of the bed 1, for example, according to invention, a person who being in the aisle 6 at the advanced bed 1, can displace the trap-door 38 into the inoperative position and open the passage trap opening 37 and move through the opening 37 and sit down on the head rest portion 19 and the back rest portion 35 and then extend the legs on the further back rest portion 35 and the legs rest portion (not shown), and displace the trap-door 38 into the horizontal operative rest position to occupy the bed 1 in sleeping mode.

During a third variant of the operation of occupation of the bed 2, for example, according to invention, a person who being in the aisle 6 at the advanced bed 2, previously displaces the visor member 39 and the collar portion 40 into the inoperative upper position, then lies down on the head and back and legs rest portions of the bed 2 and returns the visor member 39 and the collar portion 40 into the operative position to form and close off the private interior at around the head of the occupying person and prevent the ingress from the interior of the frame 12.

After the occupation, the drive means is operated to shift the occupied bed 1 or 2 or a group of the occupied beds 1 or 2 in the return direction shown by the arrows G or H in FIG. 2 through the opening into the corresponding interior of the frame 11 or 12 to cause the occupied bed 1 or 2 to be stowed in the interior for the sheltering and to urge the sealing means of the rear end wall 29 or 30 and the side wall 31 or 32 against the adjacent from above pan portion 20 or 27 of the adjacent from above bed 1 or 2 or a ceiling portion of the frame 11 or 12 to close off the private interior at the occupied rest portions in relation to the other interior of the frame 11 and 12, and urge the front wall 23 or 24 and the bin 25 or 26 against the sash portion at around the opening (not shown) of the frame 11 or 12 to close off the opening in relation to the aisle 6 to prevent the ingress (see above) into this private interior from the aisle 6.

To vacate the bed 1 or 2 which is being advanced and opened partly in the aisle 6, the occupying person can slide horizontally forward against the adjacent convenient rest steps and handles (not shown) on the pan, past along the back rest portion 35 or 36 and the head rest portion 19 or 28 and the front walls 23 or 24 and the bin 25 or 26 into the aisle 6, sit up on the head rest portion 19 or 28 and on the back rest portion 35 or 36, According to the first variant of the embodiment, the person can bend the legs throughout the opening in the frame 11 or 12 into the aisle 6 and move the feet and shins throughout the passage portion 21 and past the bin 25 or 26 into the passage portion 33 or 34 of the aisle 6.

According to the second variant of the embodiment and vacation, the person can displace the rest trap-door 38 into the inoperative position and open the passage opening 37 in the back rest portion 35 of the bed 1 and lower through the passage opening 37 with supporting on the handles and the steps on the frame 11 and 12,

According to the third variant of the embodiment and vacation, the person can previously rise the visor member 39 and the collar portion 40 into the inoperative upper position.

As it is shown at the left side half of FIGS. 1 and 2, the oblique-angled array or formation of the rails 15 in the interiors of the frames 11 and 12 according to the invention, which permits to dispose and displace and utilize a shown below quantity of the beds 1 and 2 on any length of 2 meters, for example, of the lengths of the symmetrical in relation to the axis A left and right multistoried side columns like the left column 4 and the left and right central multistoried columns like the left central column 5, the quantity is correspondingly equal to about (3 beds×3 stories+3 beds)×2=24 beds in the left column 4 and the such right side column, and 3 beds×5 stories ×2=30 beds in the left central column 5 and the such right central column, in all 54 beds, for the vertical pitch 50 centimeters, and correspondingly (3 beds×3 stories+3 beds)×2=24 beds and 3 beds×6 stories×2=36 beds, in all 60 beds for the vertical pitch 40 centimeters, in comparison with the conventional about 30 seats in the three columns on the length about 2.4 meters (about 25 seats on the length 2 meters) in the economy passenger cabin of the aircraft Boeing 747-400, for example.

The second preferred, axial straightforward embodiment of the array according to the invention, which comprises a plurality of the beds 3 located at along the aisles 9 and 10 and the frames 7 and 8. Each of the beds 3 has the conventional head rest portion 41, the back rest portion (not shown) and the thigh rest portion 42 on the pan member (not shown) and a feet and shin rest part 43 on a pan part member (not shown) which is pivotally connected to the thigh rest portion 42 and can be pivoted between a horizontal rest position and a vertical inoperative position to form and close off a vertical passage portion 44 of the aisle 9 or 10, for instance, which facilitates passing of a person to sit down on the thigh rest portion 42 and lie on the length of the back portion and head rest portion 41.

The right sided central column 7 and the right sided side column 8 can have vertical pitches of the beds 3, which is equal to about 50 and 40 centimeters correspondingly, for example.

In a first preferred variant of the straightforward embodiment of the array according to the invention, each of the beds 3 is provided with at least a front side wall 45 which being disposed on a front edge, in relation to the advancing direction shown with the arrow F in FIG. 2, of its pan and having a sealing means (explained above) for engaging from ahead on a sash portion of a facade opening, in relation to the aisle 9 or 10, (not shown) connecting the interior of the frame 13 and the aisle 9 or 10 and the interior of the frame 14 and the aisle 10.

In a second preferred variant of the straightforward embodiment of the array according to the invention, the bed 3 can be provided also with a head end wall 46 and an inner side wall 47 which being disposed correspondingly on a side and a rear edges of its pan. Each of the walls 46 and 47 has a sealing means (explained above) for engaging from beneath on the pan of the adjacent from above bed 3 or a ceiling portion of the frame 13 or 14.

In a third preferred variant of the straightforward embodiment of the array according to the invention, the bed 3 can be provided also with the head cowl comprising the visor member 39 and apron and collar portion 40 whereby the collar portion 40 can be engaged on the neck of the person which is lying on the bed 3.

Accordingly to the invention, each of the beds 3 is further provided with a private bin means 48 which being disposed in the interior at above and parallel and along the length and the width of a shin portion of the feet and shin part 43 and spaced by a clearance from an upper surface of the part 43. The clearance is equal to about a half of the pitch of the column 7 or 8 and no lesser than about 20 centimeters and no more than about 25 centimeters, for instance. The frames 13 and 14 have conventional, preferably telescopic cantilever and console, bracket and holder rail means 49.

During an operation for occupation of the bed 3 or a group of the beds 3, the bed 3 is advanced transversally in relation to the axis A and the side and the axis of the aisle 9 or 10 in the direction shown with the arrow F in FIG. 2, throughout the opening in the facade sash portion of the frame 7 or 8 to be opened into the corresponding axle 9 or 10 by supplying energy to the conventional drive means associated therewith and explained above. The opened feet and shin part member 43 can be turned into a vertical inoperative position to form the passage portion 44 of the aisle 10, for example, so as an occupying person who being in the aisle 10, can move throughout the passage portion 44 and sit down on the thigh portion 42 and then lie on other back and head rest portions of the bed 3. Then the shin and feet rest part 43 can be lifted into the horizontal operative rest position to rest the feet and shin, and occupy the whole bed 3 in sleeping mode. The person who being in the aisle 10 at the advanced bed 3, can previously displace the visor member 39 and the collar portion 40 into the inoperative upper position, then lies down on the head and back and legs rest portions of the bed 3 and returns the visor member 39 and the collar portion 40 into the operative position to form and close off the private interior at around the head and prevent the ingress from the interior of the bed 3. Then the drive means is operated to shift the occupied bed 3 in the return direction which is shown by the arrow J in FIG. 2 throughout the opening in the frame 13 or 14 into the interior of the frame 13 or 14 to cause the occupied bed 3 to be stowed in the interior to be private sheltered, and the end wall 46 and the side wall 47 to engage on the adjacent from above pan of the neighbor bed 3 and close off a private interior at the head and back and legs rest portions in relation to the interior of the frame 13 or 14 and prevent the ingress (see above) from the interior, and the sealing means of the front wall 45 to engage on the sash portion of the frame 13 or 14 around the opening and close off the opening in relation to the aisle 9 or 10 to prevent the ingress into the private interior from the aisle 9 or 10.

To vacate the opened occupied bed 3, firstly the visor member 39 and the collar portion 40 can be displaced into the inoperative upper position to open the head, and the feet and shin part 43 can be pivoted into the vertical inoperative position to form the vertical passage portion 44 of the aisle 9 or 10, and the occupying person can lower the bent feet and shin into the passage portion 44 and sit up on the thigh rest portion 42, support on the handles and steps and move throughout the passage portion 44 downward and go out.

A second variant according to the invention of the straightforward embodiment of the array of the beds 3 which comprises a number of rectangular and widened, foldable trap-shield means 50, each of which has a main part (not shown) which is supported pivotally on the frame 13 or 14, and a side part 51 which is being supported pivotally on a side edge of the main part for movement between the upper vertical, operative closing off position which being co-planed with the main part, and a lower vertical, down inoperative position, to form the passage portion 44. Edges of the main part and the side part are provided with sealing means (not shown) for engaging on the sashes of the opening of the frame 13 or 14 to close off the opening in relation to the aisle 9 or 10 and prevent the ingress (see above). The frames 13 and 14 and the trap-shield parts 50 and 51 are provided with supporting and guiding rails like the rails 15 and drive means for effecting relative movement between the frame 13 or 14 and the trap-shield parts 50 and 51 or a group of the trap-shields to effect supporting and guiding the opened bed 3 or a group of the opened beds 3 and closing-off the openings of the frames 13 or 14.

During a further variant of the private sheltering operation with using the trap-shield parts 50 and 51 and a conventional second drive means (not shown) associated therewith on the frame 13 and/or 14, and the main shield part 50, energy is supplying to the second drive means so that the single supporting and guiding trap-shield parts 50 and 51 or a group of the trap-shields pivots in relation to the frame 13 or 14 which supports and guides the trap-shield parts, into a horizontal, supporting and guiding operative position, then the first drive means open the single bed 3 or a group of the beds 3 on the trap-shield parts into the aisle 9 or 10, and then the side part 51 is pivoted into a vertical, inoperative position to form the passage portion 44 of the aisle 9 or 10 at below the rest feet and shin part 43, then the rest part 43 is pivoted into a vertical inoperative position in the passage portion 44 of the aisle 9 or 10 so as an occupying person can move throughout the passage portion 44 and sit down, preferably with the shins and feet which are extended into the passage portion 44, and lie on the thigh and back and head rest portions of the bed 3. Then the rest shin part 43 is risen into the horizontal rest operative position so as to rest the feet and the shins and to occupy the whole bed 3 in sleeping mode. Then the first drive means is operated to shift the occupied bed 3 in the return direction shown by the arrow J in FIG. 2 throughout the opening of the frame 13 or 14 into the interior of the frame 13 or 14 to cause the occupied bed 3 to be stowed and private sheltered in the interior, and the trap-shield parts 50 and 51 are pivoted into the vertical upward, closing off operative position between the aisle 9 or 10 and the opening, and the side part 51 can be pivoted into the co-planed operative position to further closing-off the opening of the frame 13 or 14 to prevent the ingress.

A group of two or three adjacent parallel beds 3 can be connected pivotally in side-by-side order together and sheltered in the widest stories of the side columns such as the side column 8, for instance, and opened on the trap-shield parts 50 and 51 into the aisle 10, and the outer one or two beds 3 can be pivoted upward into a vertical inoperative position, and the inner bed 3 can be opened in the horizontal operative position on the trap-shield parts in the aisle 10.

During an operation of occupying of the adjacent beds 3, firstly the inner horizontal bed 3 can be occupied and then shifted rearward throughout the opening into the interior of the frame 13, and the outer bed 3 is lowered in the aisle 10 into the horizontal operative position and shifted rearward into the interior, and the outer bed 3 can be occupied and shifted throughout the opening of the frame 14 with the inner bed 3 in the return direction for sheltering in the interior, and the trap-shield parts 50 and 51 is lifted (see above) to effect the private sheltering.

During an operation of vacating of the adjacent beds 3, the outer bed 3 is advanced horizontally in the direction shown with the arrow F in FIG. 2 with the inner bed 3 throughout the opening of the frame 14 into the aisle 10, for example, and vacated, then the outer bed 3 is further advanced with the inner bed 3 into the vertical inoperative position in the aisle 10 and the inner bed 3 is advanced throughout the opening of the frame 14 horizontally into the aisle 10 and vacated.

Instead of the head end wall 46 and the rear side wall 47, the frame 13, for example, can be provided with a central longitudinal divider wall 52 and transversal divider walls 53, and floor and/or ceilings (not shown) which being disposed between the walls 52 and 53, and the sash portions of the walls 53 and the floor and/or ceilings around the openings which are fronting the aisle 9 and 10, which form a plurality of private dividing and sheltering, elongate rectangular garage-shaped niches (not shown) which are being along the axes A and of the aisles 9 and 10. Each of the niches can be provided with rails like the rails 15 or 49 (see above) which are being oriented in the directions shown by the arrows F and J in FIG. 2 across the niche to the opening for supporting and guiding the bed 3, and is capable of private sheltering the occupied bed 3. According to the invention, each of the beds 3 is displaceable transversally along the rails 15 or 49 and throughout the opening between the niche and the aisle 9 or 10. Each of the niches can be provided with the bin 48.

In a first variant of the niche embodiment of the array, the bed 3 can be provided with the front side wall 45, and the niche can be provided with the rails 49. In a second variant of the niche embodiment of the array, the niches are provided with the rails like the rails 15 and with the sealing trap-shield parts 50 and 51. An inner free height of the niche can be no more than about 50 centimeters and no lesser than 40 centimeters, and an inner free length about 180 centimeters, and an inner free depth about 50 centimeters, for example.

This straightforward embodiment of the array or formation which permits to utilize on any length of 2 meters, for example, of the cabin, about 11 beds×2=22 beds 3 in two symmetrical central columns like the column 7 and about 7 beds×2=14 beds 3 in two symmetrical side columns like the right column 8, in all 36 beds 3 for the vertical pitch about 50 centimeters, and about 12 beds×2=24 beds 3 in two symmetrical central columns like the column 7 and about 8 beds×2=16 beds 3 in two symmetrical side columns like the right column 8 for the vertical pitch 40 centimeters, in all 40 beds 3.

So, the oblique-angled and straightforward economy arrays can provide the private sheltering of 54 and 36 beds on the length equal to about 2 meters of the cabin. The oblique-angled array and the method of the private sheltering according to the invention that can be especially useful. The beds of two lower stories of the columns can be desirable for using by traveler persons having limited possibilities, the beds of two upper stories can be desirable for using by healthy persons, the grouped beds can be desirable for using by sick and care travelers, and friends.

We claim:

1. An array of sleeper bed means in an occupied lodging, comprising:
a plurality of horizontally and longitudinally displaceable elongate, individual and private sleeper bed means arranged for the array into a number of horizontal multistoried columns which being located alongside a number of aisles of the lodging and a longitudinal axis of the array, and in rows across the lodging, each of the bed means having a central axis, an elongate pan member, and head rest and back rest and leg rest portions of a cushion means along the length of the member,
wherein the bed means comprises a front end wall, in relation to an advancing direction of the displacement, which being disposed on a front end edge of the pan member, and a sealing means on edges of the wall; and
a number of frame means each of which being at the column and faced to at least one the aisle, and having an interior for sheltering and supporting and guiding the occupied bed means in the advancing and opposite returning directions, and facade openings, in relation to the adjacent side of the aisle, which generally connecting the interior and the aisle and being capable of passing through longitudinally the pan member and the occupied head and back rest portions, and
drive means for effecting relative movement between the frame means and the occupied bed means,
wherein the directions being angled acutely with respect to the axis and sides of the aisle, and
the wall being parallel to the sides of the aisle and capable of closing the opening, and the sealing means being capable of engaging on sashes of the frame means around the opening to close the interior of the frame means in relation to its exterior and prevent the ingress of hindrances into the interior from the aisle; and
the drive means being to effect
occupation and vacation of the bed means from the head and back rest portions in the aisle, and
private sheltering of the occupied bed means in the interior of the frame means.

2. The array according to claim 1, wherein the sealing means is a resilient band and tube members disposed on the outsides of the wall.

3. The array according to claim 1, wherein each of the bed means has a private bin means which being disposed at ahead of the head portion on a front portion of the pan member, and serving for further closing off the interior to facilitate the privacy of the sheltering accommodation, and having the front wall, and a side wall which being disposed on an outer side edge, in relation to the aisle, of the pan member and parallel to the axis of the bed means, and a rear wall which crossing the front wall and the side wall, and a second rear wall which being disposed on a rear end of the pan member crossing the axis of the bed means and parallel the longitudinal axis of the array, and sealing means at the side wall and the rear walls for engaging on the storied bed means which being adjacent from above to close off an allotted private interior of the frame means at the bed means in relation to its exterior and prevent the ingress of hindrances into the interior from the exterior.

4. The array according to claim 3, wherein the bin means is provided with a movable door member which being disposed at an opening in a ceiling of the bin means.

5. The array according to claim 1, wherein the pan member has an elongate horizontal portion and a front ascent portion, which front portions are forming a transversal horizontal passage having generally >-shaped cross-section and serving to facilitate the occupation and vacation of the bed means which being adjacent from aside.

6. The array according to claim 1, wherein bed means further comprises a passage manhole throughout the back rest portion, which is serving to facilitate the occupation and vacating of the storied above bed means, and a back rest cover member which is pivotally connected to the pan member and can be pivoted between an operative horizontal rest position and an inoperative vertical position whereby the cover member can in the operative position close the manhole, and in the inoperative position open the manhole.

7. The array according to claim 1, wherein the bed means is further provided with a head cowl member which being disposed at the head portion and serving to close off a private head lot of the interior and sheltering the head rest portion, which cowl member having a visor portion which is pivotally connected to the pan and can be pivoted between a lower operative position and an upper inoperative position, and an apron portion which being capable of forming an opening for surrounding the neck, and a sealing collar portion at the opening for engaging on the neck to close off the head interior lot of the cowl member in relation to its exterior and prevent the ingress.

8. An array of a plurality of private sleeper beds in a lodging, the array comprising:
a plurality of horizontally and transversally displaceable private sleeper bed means arranged for the array in horizontal multistoried columns which being located alongside at least one aisle of the lodging on respective sides of a longitudinal axis of the array and in rows across the lodging, each of the bed means having a central axis and a pan member and head rest and back rest and thigh rest and feet and shin rest portions of a cushion means on the pan member, and
wherein the bed means has a front side wall, relative to the direction of advancement, which being supported on a front side edge of the pan member for privacy of the bed means, and sealing means on outer edges of the wall for engaging on the adjacent bed means; and
a number of frame means each of which being at the column. and
drive means for effecting relative movement between each of the frame means and a number of the bed means,
wherein the frame means having an interior for sheltering and supporting and guiding a number of the occupied bed means in horizontal, advancing and opposite returning directions which being perpendicular to the central and longitudinal axes and the sides of the aisle, and the plurality of facade openings, in relation to the aisle, which generally connecting the interior and the aisle and being capable of surrounding opposite ends of the occupied bed means, and a means for supporting and guiding the bed means in the perpendicular directions; and
the drive means being to effect:
occupation and vacation of each of the bed means in the aisle, and
private sheltering the occupied bed means in the interior,
whereby the wall and the sealing means are capable of closing off the opening, and the sealing means is capable of engaging on the frame means at around the opening to close off the opening in relation to the axle and prevent the ingress of hindrances into the interior from the aisle.

9. The array according to claim 8, wherein the shin and feet rest bed portion is a shin and feet rest member of the bed means, which being pivotally supported on the thigh rest portion and capable to be pivoted into a vertical inoperative position to open a vertical passage portion of the aisle toward the thigh rest portion, which passage portion serving to facilitate the simultaneous occupying and vacating of the above storied bed means.

10. The array according to claim 9, and further comprising a number of pivotable trap-shield means for supporting and guiding the bed means in the directions and closing off the openings and the interiors,
wherein each of the trap-shield means which is foldable and being composed of a main trap-shield part member which being pivotally connected to the frame means and capable to be pivoted between a vertical operative closing off position and a horizontal operative supporting and guiding position, and a side trap-shield part member serving to facilitate the occupying and vacating of the bed means and being pivotally connected to the main trap-shield part member and capable to be pivoted between a co-planed, upper vertical closing off and lower horizontal, supporting and guiding operative position and a transversal lower vertical inoperative position whereby in the inoperative position the side member forms a portion of the aisle to place the bent feet and thin.

11. The array according to claim 8, wherein a group of the adjacent horizontally bed means are pivotally connected together and at least one the outer bed means, in relation to the frame means, can be pivoted in the aisle into a vertical inoperative position.

12. The array according to claim 8, and further comprising the plurality of private bin means each of which being disposed in the interior of the frame means between the adjacent vertically thin rest portions and with a vertical clearance from the thin rest portion of the adjacent lower bed means.

13. The array according to claim 12, wherein the clearance is equal to no lesser than about 20 centimeters and no more than about 25 centimeters.

14. A method of private sheltering occupied sleeper bed means arrayed in a lodging, the method comprising:
operating a drive means to advance an occupied in sleeping mode bed means in relation to a frame means which shelters, supports and guides the occupied bed means to displace through an opening of the frame means into an adjacent aisle so as to open rest portions of the bed means in the aisle;
occupying the opened rest portions in sitting mode and all rest portions of the bed means in lying mode;
operating the drive means to shift the bed means occupied in lying mode in the opposite return direction to cause the opened rest portions to stow through the opening into the frame means, and a front wall with a sealing means on a front edge of a pan member of the bed means to engage on the frame means at around the opening and close off the opening to prevent the ingress of hindrances to the occupied rest portions from the aisle.

15. Method according to claim 14, wherein the engaging of the sealing means on the frame means is effected by operating the drive means operable to urge the front wall toward the frame means.

16. Method according to claim 14, wherein the privacy of the sheltering accommodation of the occupied bed means is further effected by
utilizing a side wall and a rear wall on an intended side edge and a rear edge of the pan member, and sealing means at edges of the side and rear walls, which are capable of engaging on the other adjacent pan member or portions of the frame means.

17. Method according to claim 16 wherein the engaging of the sealing means that is effected by
utilizing resilient sealing members capable of urging against the adjacent outside is in relation to the walls.

18. Method according to claim 14, wherein the occupying and vacating of the bed means is facilitated by displacing a feet and thin rest pan member or a back rest part member of the bed means into a inoperative position to open a vertical passage portion of the aisle toward the rest portion for occupying and vacating the bed means in sitting mode and then in sleeper mode.

19. Method according to claim 18, and further comprising the steps of:
displacing closing off and supporting and guiding, main and side trap-shield part members of a trap-shield means in relation to the frame means which supports and guides the trap-shield means so as to open the bed means into the aisle;
displacing the side member into an inoperative position to form a passage portion of the aisle for occupying in sitting mode a thigh rest portion of the bed means or vacating back and head rest portions of the bed means;
displacing the trap-shield means and the sealing means in relation to the frame means so as to partly closing off the opening with the main member and its sealing means; and
displacing the side member and its sealing means in relation to the main member so as to completely close off the opening.

20. The method according to claim 19, and further comprising the steps of occupation of a group of the bed means:
operating a drive means to advance a group of a few of the parallel bed means which being pivotally connected together in side-by-side order so as the outer bed means, in relation to the frame means, is pivoted into a vertical inoperative position in the aisle, and the inner bed means is displaced in an operative horizontal position into the aisle, and
occupying the inner bed means in sleeper mode;
operating the drive means to shift the group in the returning direction so as the inner occupied bed means is displaced into the frame means, and the outer bed means is pivoted into a horizontal operative position in the aisle;
occupying the outer bed means in sleeper mode;
operating the drive means to shift the group in the returning direction so as the occupied bed group is displaced into the frame means;
and further comprising the following steps of vacation of the group of the adjacent bed means:
operating the drive means to advance the group of the occupied bed means in the transversal direction so as the outer occupied bed means is displaced into the horizontal operative position in the aisle to be vacated;
vacating the outer bed means;
operating the drive means to further advance the group of the bed means so as the outer vacated bed means is pivot into the vertical inoperative position in the aisle, and the inner occupied bed means is displaced in the horizontal operative position into the aisle to be vacated;
vacating the outer bed means.
